(19) United States
(12) Patent Application Publication
(10) Pub. No.: US 2010/0325175 A1
(43) Pub. Date: Dec. 23, 2010

(54) DOCUMENT PROCESSING APPARATUS, DOCUMENT PROCESSING METHOD, AND STORAGE MEDIUM

(75) Inventor: Kazumi Chiba, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/786,860

(22) Filed: May 25, 2010

(30) Foreign Application Priority Data
Jun. 23, 2009 (JP) 2009-149059

(51) Int. Cl. G06F 17/30

(52) U.S. Cl. 707/805; 707/E17.005

(57) ABSTRACT

A document processing apparatus displays or does not display a template editing display unit, a database connection display unit, and a rule setting display unit in editing the template of VDP document of a VDP application with their relationship maintained and highlights a variable region in a template, a rule provided for the variable region, and an item of a database item used for the rule. Display or non-display is automatically controlled according to a user editing process so that only the minimum necessary display unit is displayed.

### BACKGROUND OF THE INVENTION

1. Field of the Invention

The present invention relates to a document processing apparatus, document processing method, and storage medium for generating, displaying and editing documents on which variable information can be printed.

2. Description of the Related Art

In recent years, the necessity of one-to-one marketing has attracted attention, which is attributed to a variety of commercial products and consumer orientation toward customized service due to dissemination of the Internet use. Such a method is very effective to increase customer satisfaction, and exploit and corral customers.

One-to-one marketing is a kind of database marketing, which generates a database of individual attribute information such as age, gender, hobby and purchase history, analyses the contents, and submits proposals according to customers' needs. A representative and specific method thereof includes a variable data print (hereinafter referred to as VDP).

The VDP is a variable data print to customize a document for each customer and output the document. VDP performs printing such that a fixed region and a variable region are arranged on a template and contents are switched page by page while data of a variable portion is being supplied from database. A template with a variable region, data input into to the variable region (hereinafter referred to as contents) and a rule for switching data in the variable region are required in order to generate the document for realizing such a VDP. The VDP document is generated by a VDP application with an editing function of the VDP document. When an instruction for printing is issued to the VDP document edited by the VDP application, the contents according to the rule are input into the variable region as print data and job control language is added to the print data to generate a print job. The print job is issued to a printing apparatus and printed out.

In the database used in the VDP, one database is generated using items (a user ID, for example) common to a plurality of databases. A rule can be set by the item of the generated database. For this reason, it is convenient if there is an editor which constructs and displays a relationship between the connection source of the database and the database generated therefrom. Hereinafter, such an editor is referred to as a database connection editor.

As the rule set in the variable region of the VDP, a conditional expression is described in the variable region and information thereof is stored into a hard disk. According to the rule, the corresponding data is extracted from the database and the variable region is replaced. Depending on the VDP application, a rule setting editor is provided which supports description of such a rule in the variable region of the template. Hereinafter, such an editor is referred to as a rule setting editor.

A conventional editing technique provides a GUI displaying contents of items of database on an editing screen of document and directly links the frame of document (refer to Japanese Patent Application Laid-Open No. 2004-213636).

A conventional technique provides a function to display contents of database by a GUI for a document to be displayed on an editing screen and directly link the contents of database with a frame. The conventional technique, however, has no function to set a rule to the frame and use the items of database therefor, so that while the conventional technique can perform different setting for each frame, it cannot perform the setting of a rule for the variable information print in which different contents are printed page by page.

If a user generates a template for a VDP document with the rule setting editor and the database connection editor displayed as an application different from the one for template editing, it is difficult to grasp their relevance, which decreases work efficiency. Furthermore, all the editors do not always need to be displayed depending on the process of template editing. On the other hand, if all the editors are displayed, it is difficult to grasp the relevance.

### SUMMARY OF THE INVENTION

The present invention is directed to a document processing apparatus including an execution unit configured to execute a layout processing using a template including a variable region associated with a rule for extracting contents to be laid out from a database, and a display control unit configured to perform display on a display unit to clarify a relationship among a specific frame of the template, an item specified in the database, and the rule set to the specific region and the item specified in the database.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of a control apparatus according to an exemplary embodiment of the present invention.

FIG. 2 is a block diagram illustrating the configuration of a software module for a document processing apparatus according to the present exemplary embodiment.

FIG. 3 is a schematic diagram of a template editing display unit.

FIG. 4 is a schematic diagram of a database connection display unit.

FIG. 5 is a flow chart describing processing for generating a database item list by connecting one or more databases.

FIG. 6 is a schematic diagram of a rule setting display unit.

FIG. 7 illustrates an example where a template editing display unit, a database connection display unit, and a rule setting display unit are simultaneously displayed with their relationship maintained.

FIG. 8 is a flow chart for setting a rule to a variable region using a display control unit and a highlight display control unit.

FIGS. 9A and 9B are schematic diagrams showing that only a necessary display unit is displayed and an unnecessary display unit is not displayed using the display control unit.

FIG. 10 illustrates an example of a partial display in which only the database item list in a database connection display unit is displayed, but the database of a connection source is not displayed.

FIG. 11 illustrates an example describing highlight display in the case where two or more rule settings are provided for a single variable region.

FIG. 12 illustrates an example describing highlight display in the case where a database item is set to the determination item of a rule and a value replaced according to the determination.

FIG. 13 is a flow chart of an automatic display of the display unit using the display control unit.

FIGS. 14A, 14B, and 14C illustrate examples describing the display by each display unit using the automatic display of the display units.

FIG. 15 illustrates a flow chart of a display control program for changing the variable region, e.g., deleting the variable region which is in the selection state in the template or changing the selection of the variable region to a different region.

FIG. 16 illustrates a flow chart of a display control program for deleting all rules provided for the variable region which is in the selection state.

### DESCRIPTION OF THE EMBODIMENTS

Various exemplary embodiments, features, and aspects of the invention will be described in detail below with reference to the drawings.

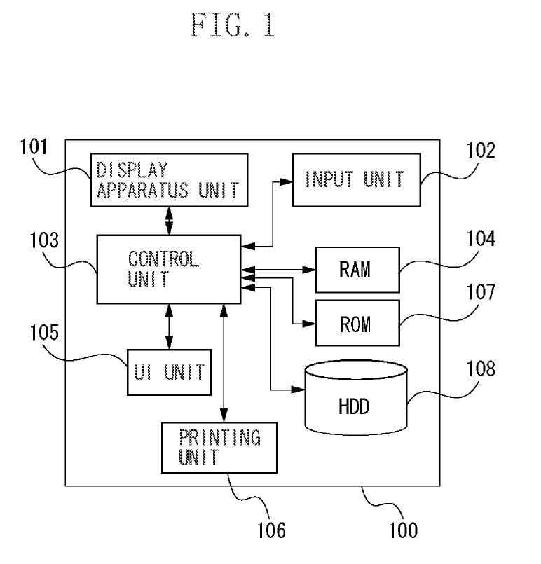

FIG. 1 is a block diagram illustrating an example of a control apparatus according to an exemplary embodiment of the present invention which is capable of executing a document processing described later.

A control apparatus (PC) 100 in FIG. 1 includes a display apparatus unit 101, an input unit 102, a control unit 103, and a UI unit 105. The display apparatus unit 101 is a display apparatus such as a CRT or a liquid crystal monitor. The input unit 102 is a pointing device such as a keyboard and a mouse.

The control unit 103 is a CPU. The control unit 103 controls the entire main apparatus according to a control program stored in a RAM 104. A ROM 107 stores a computer program executable by the control unit 103. The RAM 104 is a nonvolatile memory for storing various programs loaded from the ROM 107 and a HDD 108 and data files. The programs stored in the RAM 104 read and write the contents of data to be stored in the RAM 104, receive inputs from the input unit 102, and display the image on the display apparatus unit 101.

The HDD 108 (hard disk drive) includes a hard disk and a drive unit for reading data from and writing data into the hard disk. The HDD 108 stores a template, rule, and database. The term template refers to a document for associating a variable region on a page with information of database to set a layout. The term rule refers to a conditional expression described in the variable region of the template. The database includes one or more database used for setting rules in the variable region of the template.

The UI unit 105 receives input processing from the input unit 102 and notifies the control unit 103 of the reception thereof. The control unit 103 transmits print data to a printing unit 106. The printing unit 106 is capable of transmitting data to a printing apparatus through a network or a cable.

An OS stored in the RAM 104 executes desired data and image processing of the input processing from the input unit 102 by controlling the execution processing of various applications.

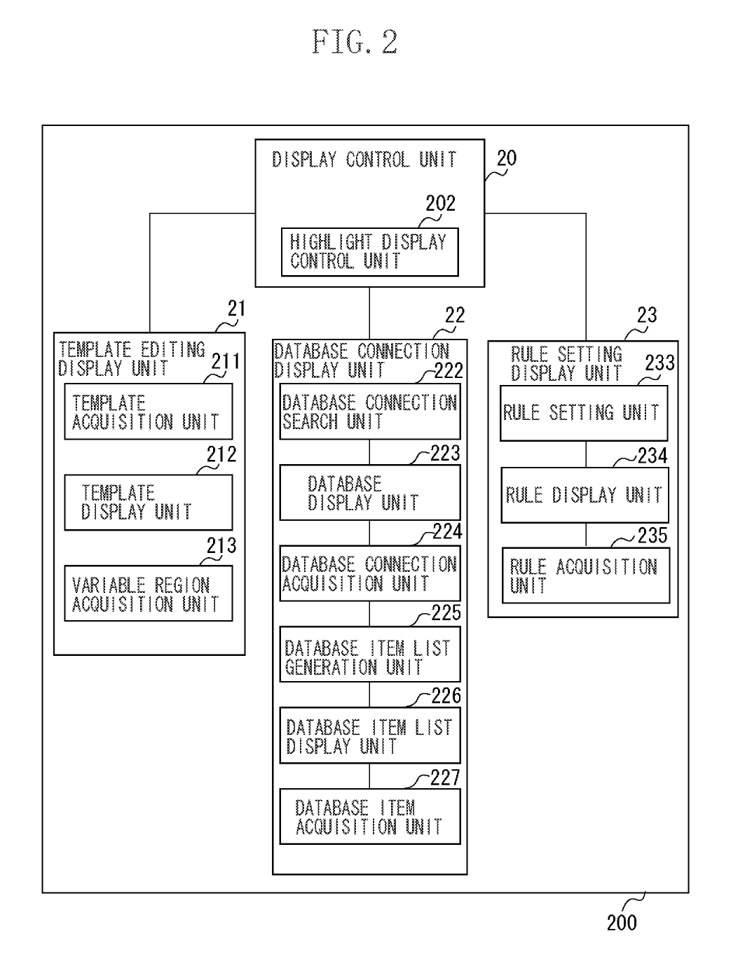

FIG. 2 is a block diagram illustrating the configuration of a software module for the document processing apparatus according to the present exemplary embodiment. A document processing apparatus 200 operates on the control apparatus 100 which is the exemplary embodiment of the document processing apparatus according to the present invention. The execution processing of each module is controlled by the control unit 103 in FIG. 1. The document processing apparatus 200 includes a display control unit 20, a template editing display unit 21, a database connection display unit 22, and a rule setting display unit 23.

The display control unit 20 acquires information about a display state and display on the template editing display unit 21, the database connection display unit 22, and the rule setting display unit 23 and issues instructions for display or non-display, or highlight display to the control unit 103 to control the display of the display apparatus unit 101. The display control unit 20 includes a highlight display control unit 202.

The display control unit 20 controls the display or non-display of the template editing display unit 21, the database connection display unit 22, and the rule setting display unit 23. The control of display or non-display is performed by receiving user's instructions for display or non-display through the input unit 102. Alternatively, the control unit 103 determines the state of display or non-display of the current display apparatus unit 101 and editing process from user's selection which the UI unit 105 receives from the input unit 102 and automatically controls the display or non-display of the display unit required by the user.

The highlight display control unit 202 acquires a template, a database item, and a rule associated by a rule setting which are set to the variable region of the template in the template editing display unit 21, the database connection display unit 22, and the rule setting display unit 23 and highlights the template, database item, and the rule. Hereinafter, information about the template, the database item, and the rule associated by the rule setting is referred to as rule setting relation information.

The template editing display unit 21 acquires a new or an edited template and displays it on the display apparatus unit 101. The template editing display unit 21 includes a template acquisition unit 211, a template display unit 212, and a variable region acquisition unit 213. The template acquisition unit 211 acquires information about a new or an edited template. The template display unit 212 displays the template acquired by the template acquisition unit 211.

In the variable region acquisition unit 213, the UI unit 105 receives the user's selection of the variable region through the input unit 102 and notifies the control unit 103 of the reception of the selection, thereby the control unit 103 acquires the selection. Hereinafter, the above state where the UI unit 105 receives the user's selection through the input unit 102 and notifies the control unit 103 of the reception of the selection and the control unit 103 acquires the selection is referred to as a selection state. If a rule is set to the variable region which is in the selection state, the control unit 103 acquires the rule setting relation information.

The database connection display unit 22 connects a plurality of databases to generate database used for setting a rule in the variable region which is in the selection state and displays a list of items of the generated database and database connection sources on the display apparatus unit 101. The database connection display unit 22 includes a database connection search unit 222, a database display unit 223, a database connection acquisition unit 224, a database item list generation unit 225, a database item list display unit 226, and a database item acquisition unit 227. The database connection search unit 222 searches for a plurality of databases related to the variable region which is in the selection state. The database display unit 223 displays the database acquired by the database connection search unit 222.

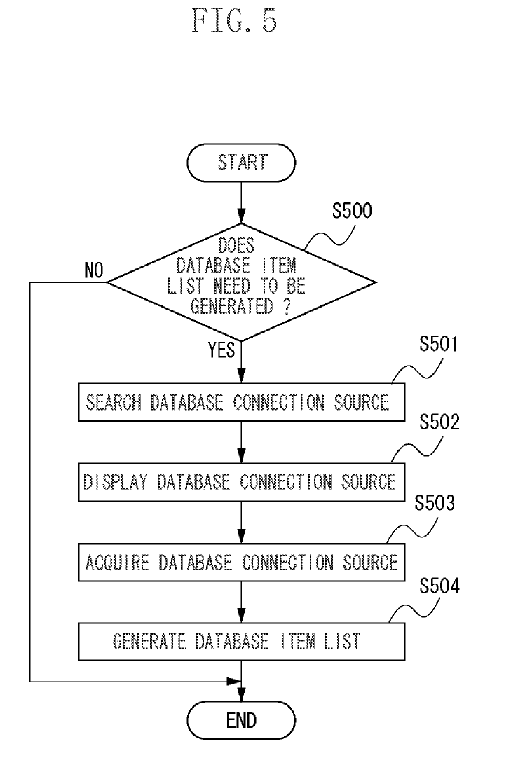

In the database connection acquisition unit 224, the UI unit 105 receives the user's selection of the database displayed by the database display unit 223 through the input unit 102 and the control unit 103 acquires the database receiving the selection. The database item list generation unit 225 connects the database acquired by the control unit 103 using items common to a plurality of databases to generate a list of items for one database. The generation of a list of items for database is described later with reference to FIG. 5.

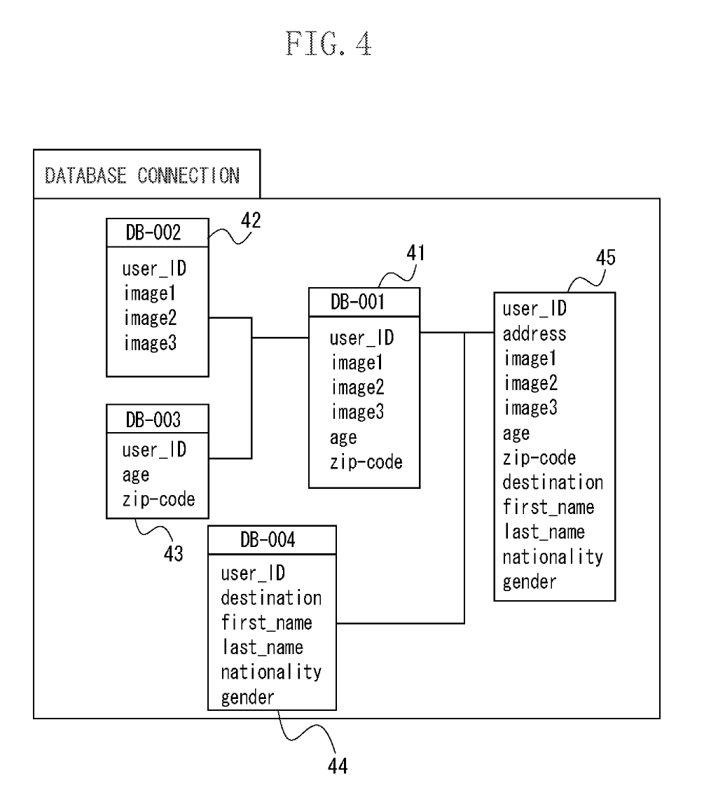

The database item list display unit 226 displays the item list generated by the database item list generation unit 225 on the display apparatus unit 101. In the database item acquisition unit 227, the UI unit 105 receives the selection of one item of the database item list displayed by the database item list display unit 226 from the input unit 102 for the user and transmits it and the control unit 103 acquires the selected item. The database connection display unit 22 is described later with reference to FIG. 4.

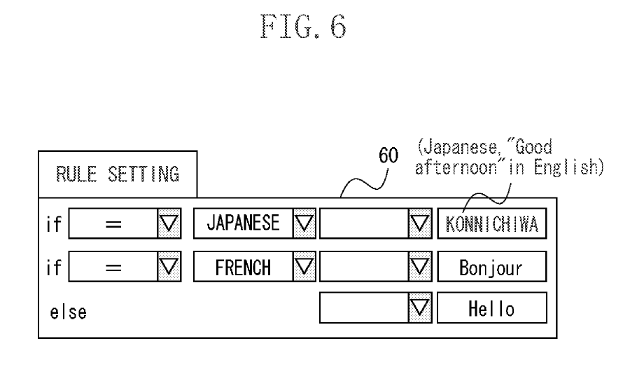

The rule setting display unit 23 displays and sets the rule in the variable region which is in the selection state. The rule setting display unit 23 includes a rule setting unit 233, a rule display unit 234, and a rule acquisition unit 235. In the rule setting unit 233, the UI unit 105 receives a rule which the user sets through the input unit 102 and notifies the control unit 103 of the reception of the rule setting. The rule acquisition unit 235 acquires the rule setting information. The rule display unit 234 displays the acquired rule setting information on the display apparatus unit 101. The rule setting display unit 23 is described later with reference to FIG. 6.

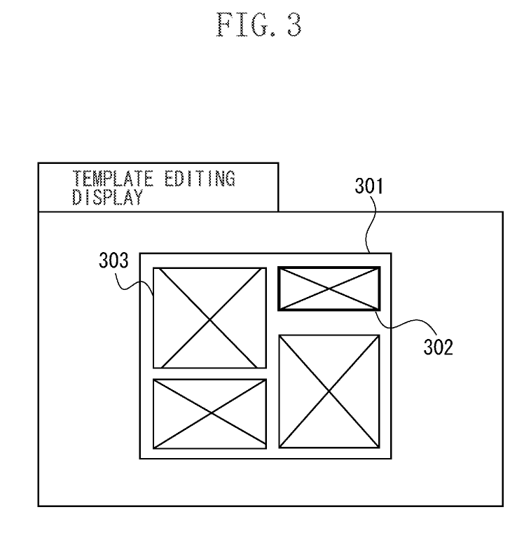

FIG. 3 is a schematic diagram of the template editing display unit 21. The template editing display unit 21 includes a template 301, a variable region 302, and a fixed region 303.

FIG. 4 is a schematic diagram of the database connection display unit 22. The database connection display unit 22 includes databases 41, 42, 43, and 44 named DB-001, DB-002, DB-003, and DB-004 respectively. The databases are stored in the HDD 108 and can be searched by the database connection search unit 222. The database item list generation unit 225 connects the databases using the items common to the four databases “user_ID” to generate a database item list 45.

FIG. 5 is a flow chart describing a database item list generation processing program for generating a database item list, using the database connection unit 22 in FIG. 4, by connecting databases. The database item list generation processing program is stored in the HDD 108, read into the RAM 104 by the control unit 103 and executed. In step S500, the display control unit 20 determines whether a database item list needs to be generated. If the database item list is not yet generated or a user requests that the database item list is generated, the display control unit 20 determines that the database item list needs to be generated. If the database item list does not need to be generated (NO in step S500), the processing is ended. If the database item list needs to be generated (YES in step S500), in step S501, the database connection search unit 222 searches for databases. In step S502, the database acquired as a result of the database connection search is displayed by the database display unit 223 on the display apparatus unit 101. In step S503, the database connection acquisition unit 224 receives the selection of databases from the user and the control unit 103 acquires the selection. In step S504, the items common to the databases are acquired from the selected databases to generate the database item list by the database item list generation unit 225.

FIG. 6 is a schematic diagram of the rule setting display unit 23. A rule setting 60 is the one in which a rule provided for the variable region of the template is displayed and edited, and hereinafter referred to as rule setting. According to the rule in FIG. 6, for example, if data of the item “Nationality” in the database is “Japanese,” the contents of [symbol] (Konnichiwa)” (or, Good afternoon! in English) are extracted, arranged in a specific frame of the template and printed. If data of the item “Nationality” in the database is “French,” the contents of “Bonjour” are extracted, arranged in a specific frame of the template and printed. If data of the item “Nationality” in the database is neither “Japanese” nor “French,” “Hello” is inserted into a specific frame of the template and printed. The rule setting display unit 23 receives the editing of the rule setting 60 from the user. The control unit 103 acquires the rule setting and stores it into the HDD 108. By setting the rule to the variable region, data in the variable region can be replaced in collaboration with the contents of item of the database item list.

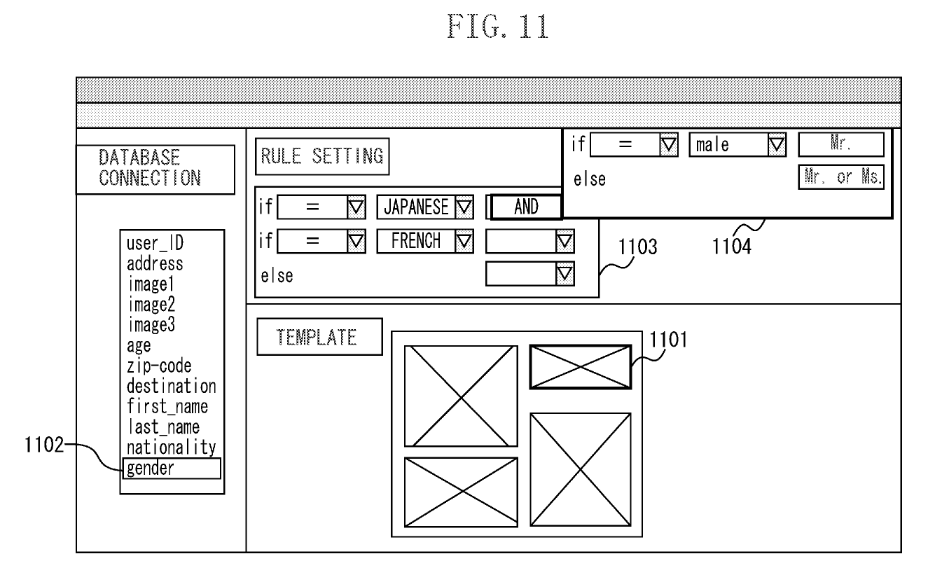

An example is described below in the case where “Nationality” in the database item list is specified as a database item. The rule setting 60 represents the rule of “IF nationality=‘JAPANESE’ [symbol] (Konnichiwa)’ else if nationality=‘FRENCH’ ‘Bonjour’ else ‘Hello.’” The control unit 103 acquires the item “nationality” from the database according to the rule and if “nationality” of each record is JAPANESE, the variable region is replaced with [symbol] (Konnichiwa).” If “nationality” is FRENCH, the variable region is replaced with “Bonjour.” If “nationality” is neither JAPANESE nor FRENCH, the variable region is replaced with “Hello.” FIG. 6 illustrates an example where a character string is replaced according to the determination item of the rule. An object to be replaced may be image data or database item. A plurality of rules may be set to one variable region. In that case, rules are branched by AND or OR. This example is described later with reference to FIG. 11.

In the document processing apparatus, the display control unit 20 simultaneously displays the template editing display unit 21, the database connection display unit 22 used for the rule setting in which a rule is provided for the variable region of the template, and the rule setting display unit 23 on the display apparatus unit 101 with their relationship maintained.

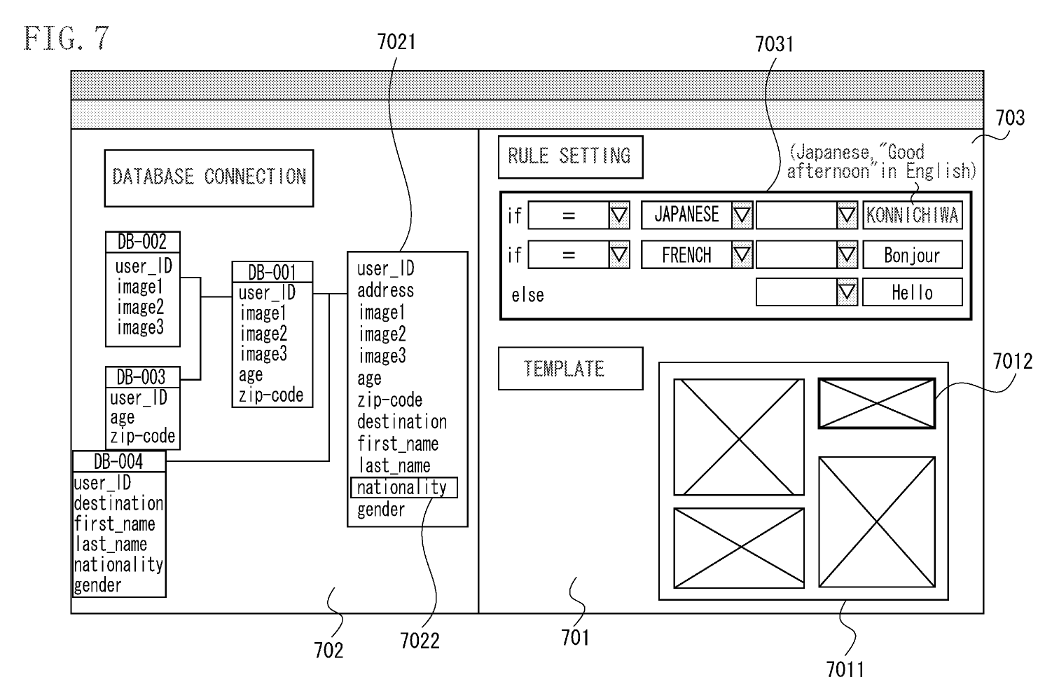

FIG. 7 illustrates an example where the template editing display unit 21, the database connection display unit 22, and the rule setting display unit 23 are simultaneously displayed with their relationship maintained. Reference numerals 701, 702, and 703 denote the template editing display unit 21, the database connection display unit 22, and the rule setting display unit 23 respectively. The simultaneous display includes a template 7011, a variable region 7012, a database item list 7021, an item of a database item list 7022, and a rule setting 7031.

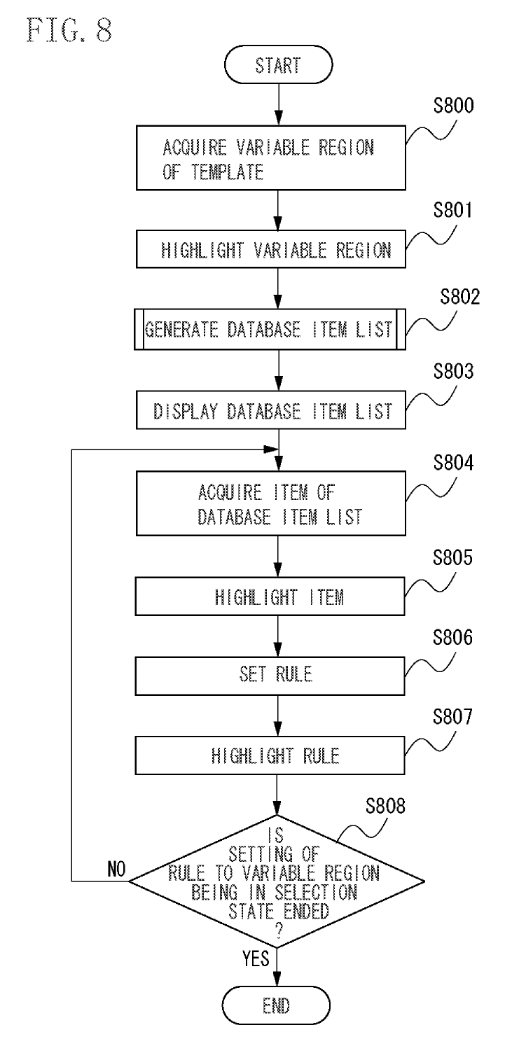

FIG. 8 is a flow chart for setting a rule to the variable region using the display control unit 20 and the highlight display control unit 202. The rule setting program is stored in the HDD 108, read into the RAM 104 by the control unit 103 and executed. The flow chart in FIG. 8 is executed by the control unit 103 using the module configuration in FIG. 2 according to the present exemplary embodiment. The flow chart describes the setting of the rule to the variable region 7012 in the case where the display units are simultaneously displayed as illustrated in FIG. 7.

In step S800, the selection of the variable region 7012 of the template is received. In step S801, the highlight display control unit 202 highlights the variable region 7012 which is in the selection state. In step S802, the database item list generation processing described by using the flow chart in FIG. 5 is performed. In step S803, the display control unit 20 displays the database item list 7021. In step S804, the selection of the database item list 7022 is received from the user. In step S805, the highlight display control unit 202 highlights the database item list 7022 acquired when the selection is received. In step S806, the control unit 103 acquires the rule from the rule setting 7031 set between the variable region 7012 which is in the selection state and the database item list 7022 at the rule acquisition unit 235. In step S5807, the highlight display control unit 202 highlights the rule setting 7031. In step S808, if the setting of the rule to the variable region 7012 which is in the selection state is completed in whole, the setting of the rule to the variable region 7012 which is in the selection state is ended. If there is a plurality of the rule settings 7031 set to the variable region 7012 which is in the selection state, the processing from step S804 to step S807 are repeated.

The document processing apparatus causes the display control unit 20 to display a necessary display unit and not to display an unnecessary display unit among the display units.

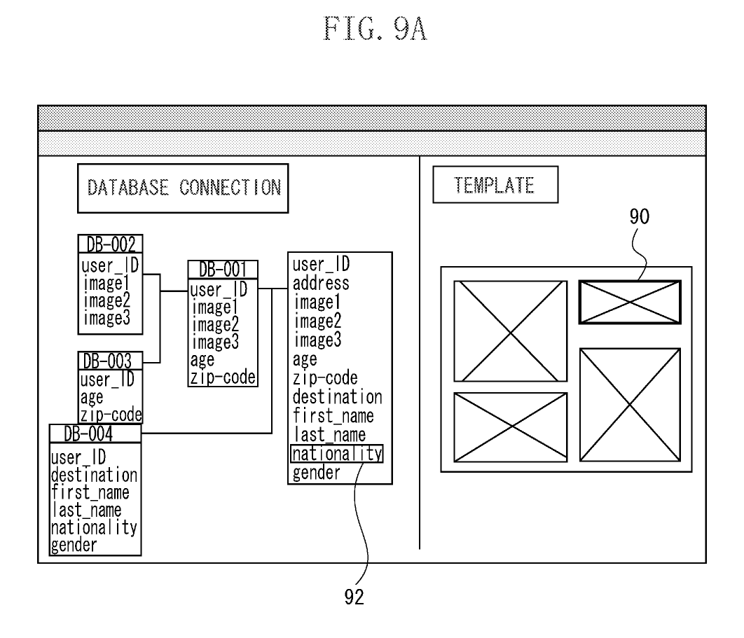

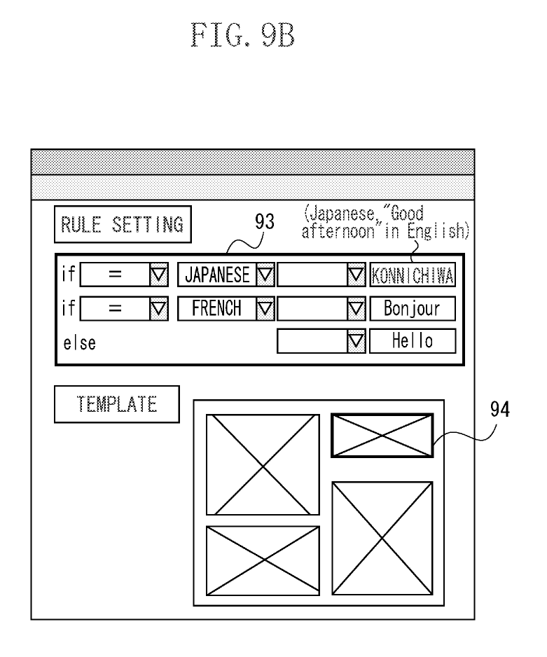

FIGS. 9A and 9B are schematic diagrams showing that only a necessary display unit is displayed and an unnecessary display unit is not displayed using the display control unit.

FIG. 9A is a schematic diagram showing that only the rule setting display unit 23 is not displayed using the display control unit 20. In FIG. 9A, the display control unit 20 displays the template editing display unit 21 and the database connection display unit 22, but does not display the rule setting display unit 23.

FIG. 9B is a schematic diagram showing that the database connection display unit 22 is not displayed using the display control unit 20. In FIG. 9B, the display control unit 20 displays the template editing display unit 21 and the rule setting display unit 23, but does not display the database connection display unit 22. When an unnecessary display unit is not displayed, the highlight display control unit 202 highlights information related to the setting of the rule in the currently displayed display units. In other words, in FIG. 9A, the highlight display control unit 202 highlights a variable region 90 and an item 92 of the template editing display unit 21 and the database connection display unit 22 respectively, which are currently displayed. In FIG. 9B, the highlight display control unit 202 highlights a variable region 94 and a rule setting 93 of the template editing display unit 21 and the rule setting display unit 23 respectively.

The document processing apparatus causes the display control unit 20 not to display an unnecessary display unit among the display units.

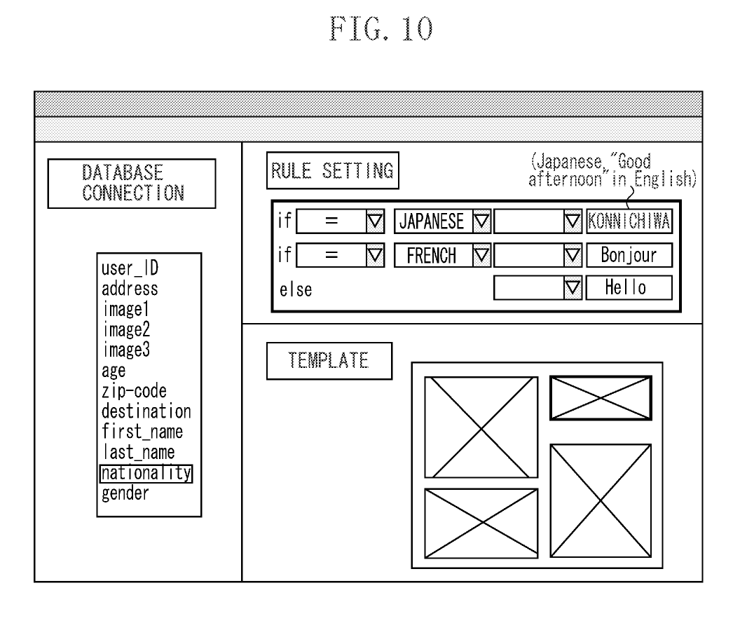

FIG. 10 illustrates an example of a partial display in which only the database item list in the database connection display unit 22 is displayed, but the database of the connection source is not displayed.

The database connection display unit 22 connects databases to generate the database item list. If the database item list can be used and does not need to be generated afterward, it may be enough to display only the database item list. For this reason, the display control unit 20 receives an instruction for display or non-display from the user and the control unit acquires the instructions, thereby only the database item list in the database connection display unit 22 is displayed. If only the minimum necessary display portion is displayed, a display which is suited for a purpose and good in visibility is performed, which enables an efficient work.

The partial display of the database connection display unit 22 is described above. Also in the rule setting display unit 23 and the display control unit 20, the display control unit 20 receives an instruction for display or non-display from the user to enable the display of a portion of the display unit.

Hereinafter, for the sake of simplicity, the following is described on the premise that the database item list has been already generated and the database connection source does not need to be displayed.

In the document processing apparatus, the highlight display control unit 202 highlights the rule setting relation information.

A highlight display in FIG. 7 is described below. In FIG. 7, the variable region 7012 in the template 7011 is in the selection state. The item “nationality” 7022 in the database item list 7021 is selected and the rule setting 7031 of the variable region 7012 in the selection state and the selected database item 7022 is set to the variable region 7012 in the selection state. In this case, the variable region 7012, the item “nationality” 7022 in the database item list 7021, and the rule setting 7031 are highlighted. In the present exemplary embodiment, although the highlight is performed by using a square or a circle, other highlight methods may be used as far as they are prominent to eyes, for example, the color of characters is changed or a bold font is used. This enables clearly displaying the database item and rule setting associated with the variable region in the selection state on the display apparatus unit 101.

FIG. 11 illustrates an example describing highlight in the case where two or more rule settings are provided for a single variable region. The example illustrated in FIG. 11 can be realized by executing the flow chart in FIG. 8. If a plurality of rules is set to the variable region, rules are connected by AND or OR. In FIG. 11, the rule settings 1103 and 1104 are connected by AND and set to the variable region 1101. The determination item of the rule in the rule setting 1103 is similar to that in the rule setting 7031. The rules in which the rule setting 1103 is connected to the rule setting 1104 by AND are represented by “if nationality=‘JAPANESE’ AND gender=‘male’ [symbol] (shi)’ else ‘ [symbol] (san)’.” If “nationality” is JAPANESE and “gender” is male, the rule provided for the variable region is replaced with [symbol] (shi)” (or, Mr. in English), or otherwise, with [symbol] (san)” (or, Mr. or Ms. in English). If two or more rules are set to the variable region, only the rule setting selected by the user is highlighted. In FIG. 11, the rule setting 1104 is selected by the user.

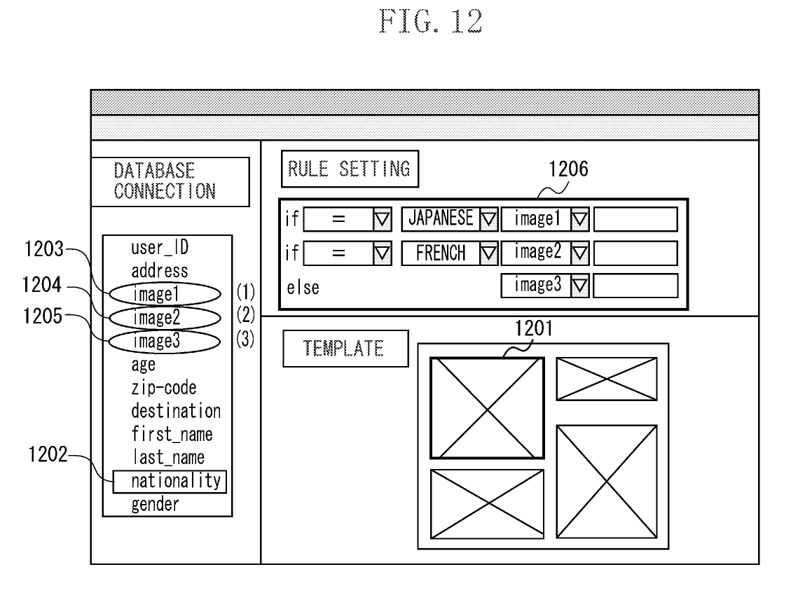

FIG. 12 illustrates an example describing highlight in the case where both the determination item of the rule and the values replaced according to the determination are displayed on the database item list. In FIG. 12, the rule 1206 provided for the variable region 1201 uses “the determination item of the rule” 1202 and “the values replaced according to the determination” 1203, 1204, and 1205. The selection of the variable region 1201 is received from the user and then the selection of “the item of the database item list” 1202. Thereafter, the rule setting display unit 23 receives image 1, image 2, and image 3 specified as the values replaced according to the determination using the rule setting 1206. Thus, the highlight display control unit 202 highlights image 1, image 2, and image 3 in the database connection display unit 22.

The rule setting 1206 represents “nationality=‘JAPANESE’ image 1 else if nationality=‘FRENCH’ image 2 else image 3.” Using this rule, if “nationality” is “JAPANESE,” the variable region 1201 is replaced with image 1. If “nationality” is “FRENCH,” the variable region 1201 is replaced with image 2. Otherwise, the variable region 1201 is replaced with image 3. In the example of FIG. 12, “the determination item of the rule” 1202 is highlighted by a square surrounding it and “the items set as the values replaced according to the determination” 1203 and 1204 are highlighted by ovals surrounding them. As a method of highlight, highlighting them by changing colors, for example, may be used if it is distinguishable between the determination item of the rule and the values replaced according to the determination. If two or more items of the database item list as the values replaced according to the determination are set, the numerals (1) and (2) are affixed, as illustrated in FIG. 2. However, other distinguishable methods may also be used.

If the highlight display control unit 202 determines that highlight is unnecessary, the highlight is cancelled. For example, when the user instructs the highlight display control unit 202 to add or delete a rule, the highlight display control unit 202 cancels the highlight of the variable region of the template, the item of the database item list and the rule. More specifically, the deletion of the rule cancels the highlight of a database item field. The deletion of the frame of the template removes the rule setting region and the database item field from the screen to leave only the template on the screen.

In the document processing apparatus, the display control unit 20 automatically controls the display or non-display of the display unit to display only the minimum necessary display unit.

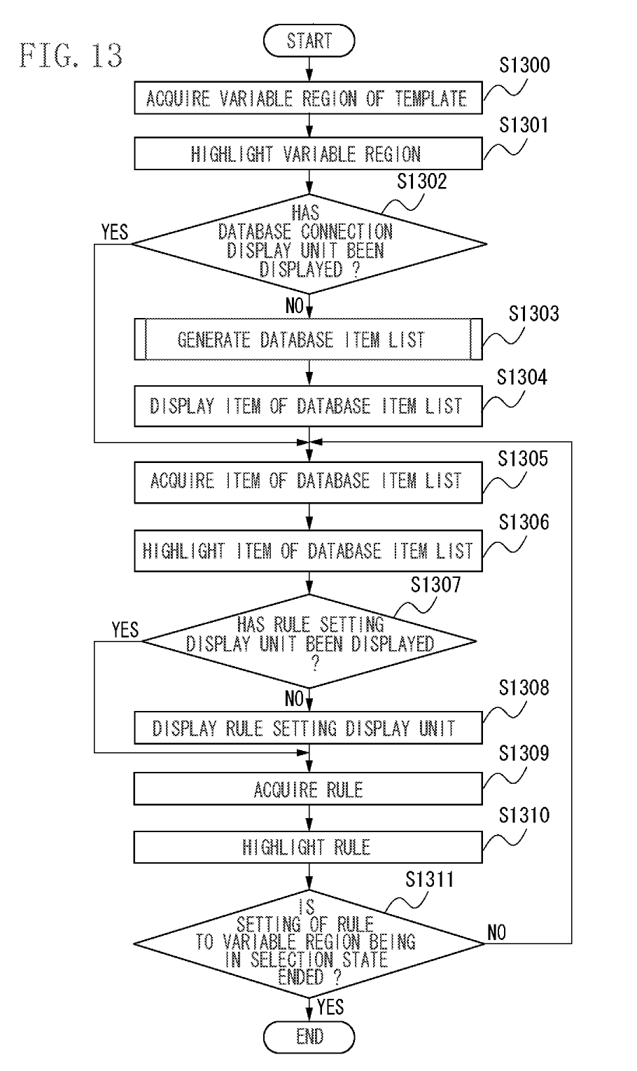

FIG. 13 is a flow chart of an automatic display program of the display unit using the display control unit 20. The automatic display program of the display unit is stored in the HDD 108, read into the RAM 104 by the control unit 103 and executed.

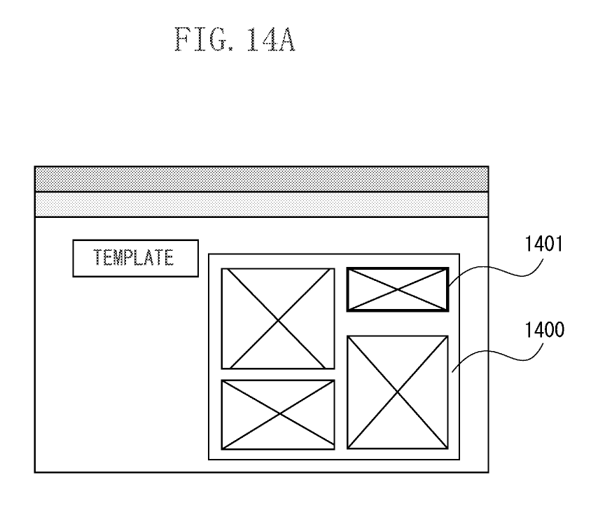

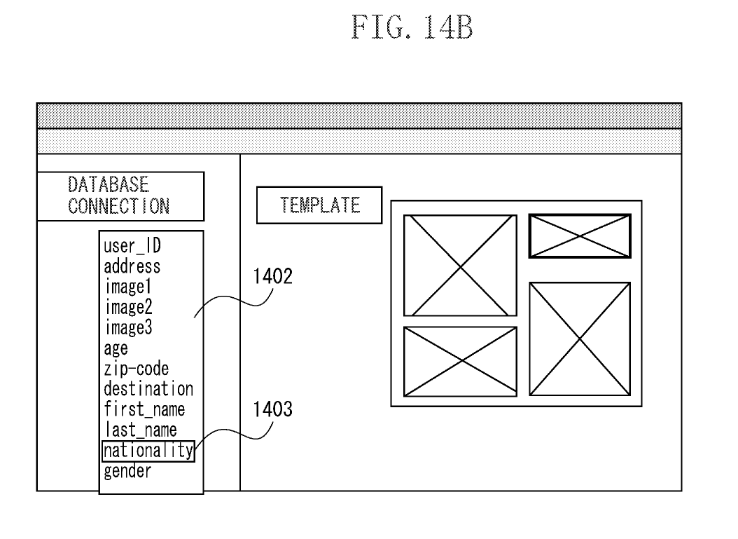

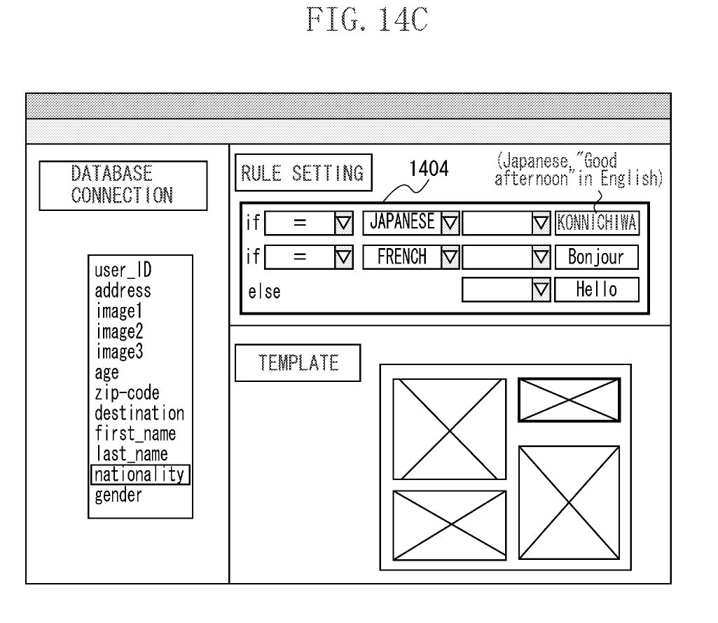

FIGS. 14A, 14B, and 14C illustrate examples describing the display of each display unit using the automatic display of the display unit in FIG. 13. In an initial state, a template is read into the template editing display unit 21. As illustrated in FIG. 14A, when the minimum necessary display is automatically performed, only a template 1400 is displayed on the template display unit immediately after the template is read. In step S1300, the UI unit 105 receives the selection of a specific variable region 1401 in the template 1400 from the user. The control unit 103 acquires the selection. In step S1301, the specific variable region 1401 in the selection state is highlighted.

After the specific variable region 1401 is selected, the item of the database item list needs to be specified by the database connection display unit 22. Therefore, in step S1302, the control unit 103 determines whether the database connection display unit 22 is displayed. If the database connection display unit 22 is displayed (YES in step S1302), the processing in step S1305 is performed. If the database connection display unit 22 is not displayed (NO in step S1302), in step S1303, the database item list is generated as described in the flow chart in FIG. 5. As illustrated in FIG. 14B, in step S1304, a database item list 1403 which is required in order to set a rule in the database connection display unit 22 is displayed. In step S1305, the UI unit 105 receives the selection of the database item 1403 from the user. In step S1306, the control unit 103 acquires and highlights the selected database item 1403.

In step S1307, the control unit 103 determines whether the rule setting display unit 23 is displayed so that a rule is set to the variable region which is in the selection state using the acquired database item 1403. If it is determined that the rule setting display unit 23 is displayed (YES in step S1307), the processing in step S1309 is performed. If it is determined that the rule setting display unit 23 is not displayed (NO in step S1307), as illustrated in FIG. 14C, in step S1308, the rule setting display unit 23 is displayed. In step S1309, the rule acquisition unit 235 receives a rule setting from the user and notifies the control unit 103 of the reception of the rule setting. The control unit 103 acquires the rule provided for the variable region which is in the selection state. In step S1310, the control unit 103 displays the acquired rule as the rule setting 1404 on the rule setting display unit 23 and highlights the rule setting 1404. In step S1311, the control unit 103 determines whether the rule needs to be further set to the variable region which is in the selection state. If the rule does not need to be set (NO in step S1311), setting the rule to the variable region is ended. If the rule needs to be set (YES in step S1311), the processing returns to step S1305 and the processing from S1305 to S1310 is repeated. At this point, the database connection display unit 22 and the rule setting display unit 23 are displayed, so that it is determined that the rule setting display unit 23 has been already displayed in the branch of step S1307.

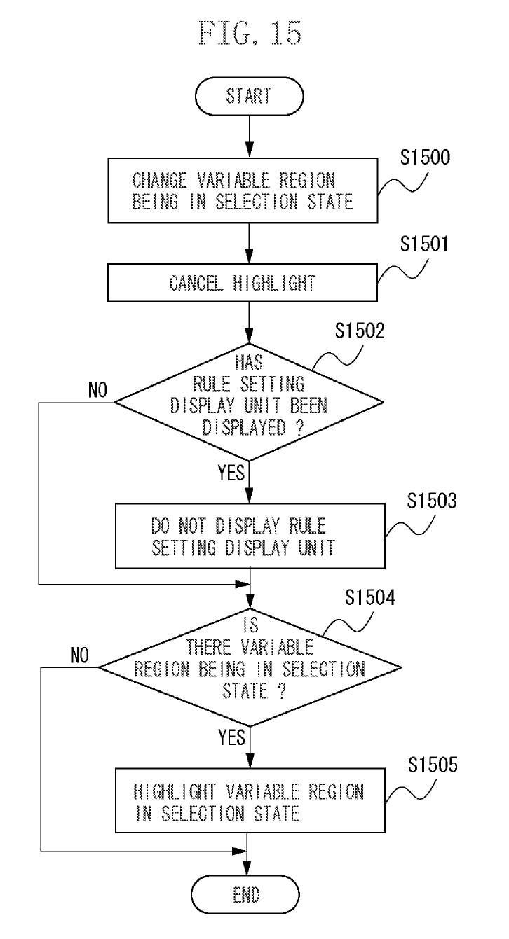

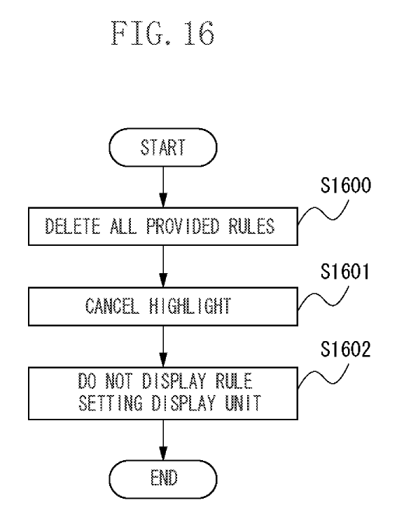

FIGS. 15 and 16 illustrate flow charts describing the automatic non-display of the display unit using the document processing apparatus according to the present invention.

FIG. 15 illustrates a flow chart of a display control program for changing the variable region, e.g., by deleting the variable region which is in the selection state in the template or by changing it to the selection of a different region. The display control program is stored in the HDD 108, read into the RAM 104 by the control unit 103 and executed.

In step S1500, the UI unit 105 receives the change of selection of the variable region from the user. In step S1501, the control unit 103 acquires the change of selection of the variable region and cancels all the highlights. In step S1502, the control unit 103 determines whether the rule setting display unit 23 has been already displayed. If it is determined that the rule setting display unit 23 has not yet been displayed (NO in step S1502), the processing in step S1504 is performed.

If it is determined that the rule setting display unit 23 has been already displayed (YES in step S1502), in step S1503, the rule setting display unit 23 is not displayed. In step S1504, the control unit 103 determines whether there is a variable region newly rendered in the selection state. If there is no variable region which is in the selection state (NO in step S1504), the display control is ended. If there is a variable region newly rendered in the selection state (YES in step S1504), in step S1505, the control unit 103 acquires and highlights the variable region newly rendered in the selection state in the template.

FIG. 16 illustrates a flow chart of a display control program for deleting all rules provided for the variable region which is in the selection state. The display control program is stored in the HDD 108, read into the RAM 104 by the control unit 103 and executed.

In step S1600, the UI unit 105 receives the deletion of setting of all rules from the user. In step S1601, the control unit 103 acquires information in which the setting of all rules is deleted and cancels all the highlights. In step S1602, the control unit 103 causes the rule setting display unit 23 not to be displayed.

As described above, the display control unit 20 predicts the following work from user's current work to automatically control the display or non-display of each display unit so that only the minimum necessary display unit is displayed. This improves the visibility of the user to allow effective editing processing.

According to the exemplary embodiment of the present invention, the template editing display unit, the rule setting display unit, and the database connection display unit are simultaneously displayed with their relationship maintained in editing the template of VDP document. Thus, the template can be edited while the relationship between database connection and rule setting is being confirmed. The variable region in the template, database item, and rule setting which are associated with one another are highlighted to enable their relationship to be visually recognized even by a minimum necessary display. The display or non-display of each display unit is automatically controlled so that only the minimum necessary display unit is displayed according to a user editing process, so that effective document editing can be performed. According to the exemplary embodiment of the present invention, the template can be edited while the relationship among the variable region in the template, the database connection and the rule setting is being confirmed.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-149059 filed Jun. 23, 2009, which is hereby incorporated by reference herein in its entirety.

What is claimed is:

1. A document processing apparatus, comprising:
an execution unit configured to execute a layout processing using a template with a variable region associated with a rule for extracting contents to be laid out from a database; and
a display control unit configured to perform display on a display unit to clarify a relationship among a specific region of the template, an item specified in the database, and the rule set to the specific region and the item specified in the database.

2. The document processing apparatus according to claim 1, wherein the display control unit highlights the specific region in the template, the item specified in the database, and the rule set to the specific region and the item specified in the database.

3. The document processing apparatus according to claim 2, wherein, when a plurality of rules is set to a single specific region, the display control unit highlights the specific region in the template, a rule for receiving a setting from a user, and a database item used for the rule for receiving the setting.

4. The document processing apparatus according to claim 2, wherein the display control unit highlights a determination item of the rule and an item of a value replaced according to the rule if the database item is used for both the determination item of the rule and the value replaced according to the rule.

5. The document processing apparatus according to claim 2, wherein the display control unit unhighlights the specific region in the template, the item specified in the database, and the rule set to the specific region and the item specified in the database if there is no relationship among the highlighted items.

6. The document processing apparatus according to claim 1, wherein the display control unit displays a database item list if the specific region of the template is selected, and the display control unit displays a rule setting region if an item of the database item list is selected.

7. A document processing method for executing a layout processing using a template including a variable region associated with a rule for extracting contents to be laid out from a database, the method comprising performing display on a display unit to clarify the relationship among a specific region of the template, an item specified in the database, and the rule set to the specific region and the item specified in the database.

8. The document processing method according to claim 7, further comprising highlighting the specific region in the template, the item specified in the database, and the rule set to the specific region and the item specified in the database.

9. The document processing method according to claim 8, further comprising, when a plurality of rules is set to a single specific region, highlighting the specific region in the template, a rule for receiving a setting from a user, and a database item used for the rule for receiving the setting.

10. The document processing method according to claim 8, further comprising highlighting a determination item of the rule and an item of a value replaced according to the rule if the database item is used for both the determination item of the rule and the value replaced according to the rule.

11. The document processing method according to claim 8, further comprising unhighlighting the specific region in the template, the item specified in the database, and the rule set to the specific region and the item specified in the database if there is no relationship among the highlighted items.

12. The document processing method according to claim 7, further comprising displaying a database item list if the specific region of the template is selected, and displaying a rule setting region if an item of the database item list is selected.

13. In a document processing apparatus configured to execute a layout processing using a template including a variable region associated with a rule for extracting contents to be laid out from a database, a computer-readable storage medium storing computer-executable instructions which, when executed by a computer, cause the computer to perform operations comprising:
performing display on a display unit to clarify the relationship among a specific region of the template, an item specified in the database, and the rule set to the specific region and the item specified in the database.

14. The computer-readable storage medium according to claim 13, the operations further comprising:
highlighting the specific region in the template, the item specified in the database, and the rule set to the specific region and the item specified in the database.

15. The computer-readable storage medium according to claim 14, the operations further comprising:
when a plurality of rules is set to a single specific region, highlighting the specific region in the template, a rule receiving a setting from a user, and a database item used for the rule receiving the setting.

16. The computer-readable storage medium according to claim 14, the operations further comprising:
highlighting a determination item of the rule and an item of a value replaced according to the rule if the database item is used for both the determination item of the rule and the value replaced according to the rule.

17. The computer-readable storage medium according to claim 14, the operations further comprising:
unhighlighting the specific region in the template, the item specified in the database, and the rule set to the specific region and the item specified in the database if there is no relationship among the highlighted items.

18. The computer-readable storage medium according to claim 13, the operations further comprising:
displaying a database item list if the specific region of the template is selected, and displaying a rule setting region if an item of the database item list is selected.
